(19) United States
(12) Patent Application Publication
(10) Pub. No.: US 2008/0273859 A1
(43) Pub. Date: Nov. 6, 2008

(54) Marking Program Boundaries in a Personal Video Recording Device

(75) Inventor: Gerardus Henricus Broeksteeg, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONONKLIJKE PHILIPS ELECTRONICS N.V., EINDHOVEN (NL)

(21) Appl. No.: 10/598,192

(22) PCT Filed: Jan. 6, 2005
(86) PCT No.: PCT/IB2005/050069

§ 371 Date: Aug. 12, 2006

Related U.S. Application Data
(60) Provisional application No. 60/576,226, filed on Jun. 2, 2004.

(30) Foreign Application Priority Data
Jan. 8, 2004 (EP) 04075002.8

(51) Int. Cl. H04N 5/91; H04N 5/00

(52) U.S. Cl. 386/83; 386/126; 386/E05.064

(57) ABSTRACT

The present invention is directed to a method of recording an audio and video input signal. The method includes the input signal being received. The input signal being stored in a buffer. A program change being detected in the input signal. A program marker being inserted into the buffer corresponding to the program change.

The present application is based on Provisional Application filed in the European Patent Office, Serial No. 04075002.8, on Jan. 8, 2004.

The present invention relates generally to personal video recording devices, and more particularly, to a personal video recording device that marks program boundaries in an input signal being stored in a buffer.

Personal video recording devices have been developed in order to enhance a person's television viewing experience. An example of such a device is the TIVO product. A personal video recorder generally includes a hard disk drive that is integrated with a television encoding system. The hard disk drive usually has an area reserved to act as a buffer. The buffer is used to continually store the program currently being watched by a user. This buffering allows a user to manipulate the program being watched by a number of trick modes including rewind, fast-forward or pause.

However, in some of these personal video recorders, the buffer capacity is fixed. For example, the TIVO only has a buffer capacity of thirty minutes. Thus, if such a device is paused for more than thirty minutes, a user will not be able to view the entire portion of the program missed. Only the last thirty minutes of the program can be viewed from when the user restarts such a device.

Another limitation with some of these personal video recorders is that there is no indication in the buffer when the program changes. For example, a user may be watching a program on a channel, which is also being continuously stored in the buffer of the personal recording device. If the user changes the channel or if a new program starts on the same channel, the new program is then continuously stored in the buffer. However, there is no indication in the buffer where this change occurs. Therefore, if a user wanted to go back and view the first program, he would have to spend time rewinding the device in order to find the first program.

In view of the above, the present invention is directed to a method of recording an audio and video input signal. The method includes the input signal being received. The input signal being stored in a buffer. A program change being detected in the input signal. A program marker being inserted into the buffer corresponding to the program change.

In one example, the program change is a change from a first channel to a second channel. The program marker is inserted if the second channel has a duration of more than a predetermined period. The program marker is inserted if a program on the second channel has a duration of more than a predetermined time period.

In another example, the program change is a change from a first program to a second program on the same channel. The program marker is inserted if a second program has a duration of more than a predetermined time period.

The present invention is also directed to a device for recording an audio and video input signal. The device includes a switch for receiving the input signal. An audio and video coding unit for encoding the input signal. A buffer for storing the encoded input signal. A controller for detecting a program change in the input signal and inserting a program marker into the buffer corresponding to the program change.

Referring now to the drawings where like reference numbers represent corresponding parts throughout:

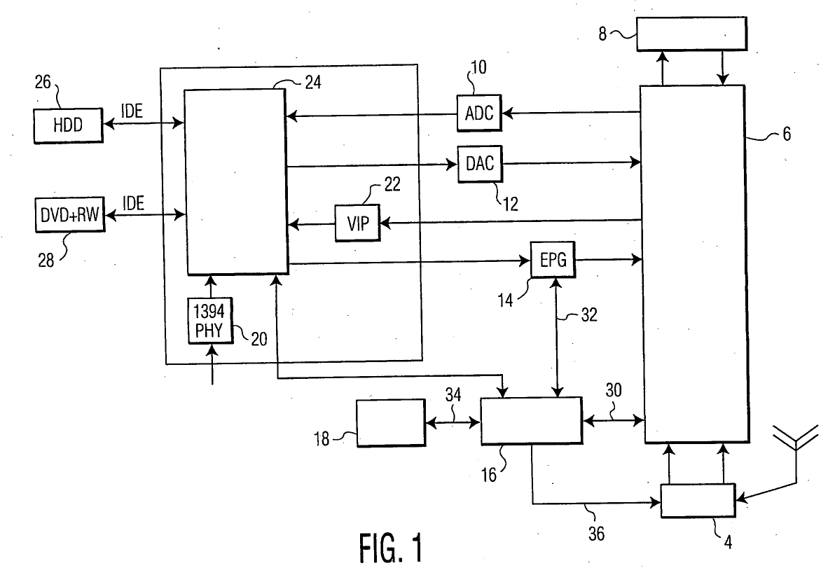

FIG. 1 is a diagram showing one example of a personal video recording device according to the present invention;

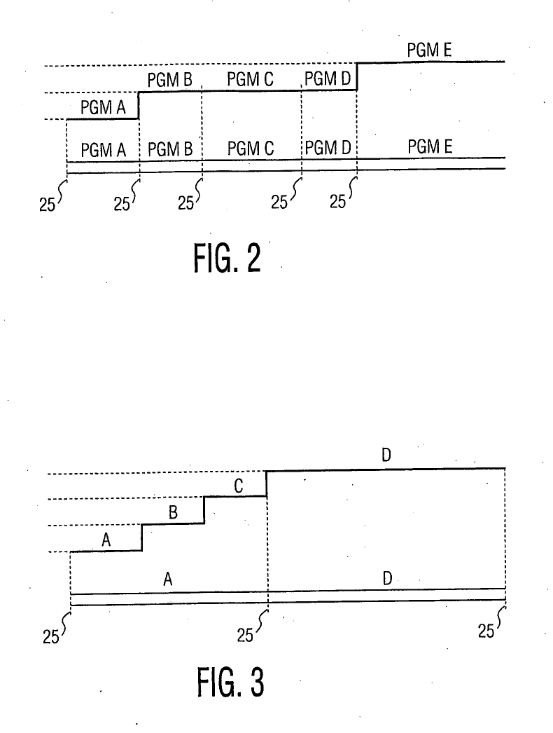

FIG. 2 is a diagram showing one example of storing programs in a buffer according to the present invention;

FIG. 3 is a diagram illustrating another example of storing programs in a buffer according to the present invention;

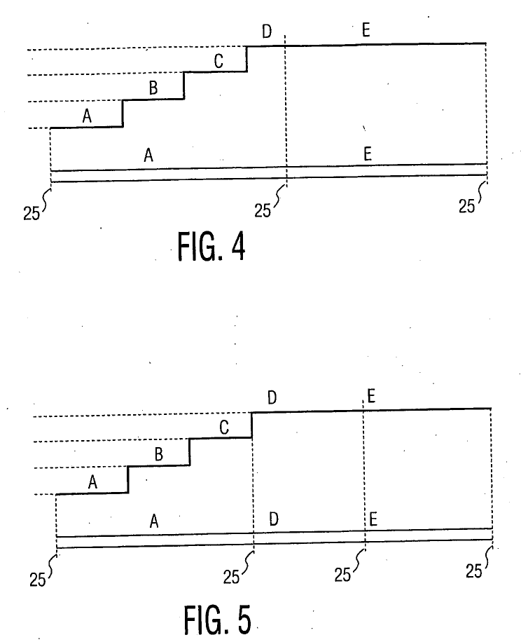

FIG. 4 is a diagram illustrating another example of storing programs in a buffer according to the present invention; and

FIG. 5 is a diagram illustrating another example of storing programs in a buffer according to the present invention.

One example of a personal video recording device according to the present invention is shown in FIG. 1. As can be seen, a tuner 4 is included for receiving a television signal. The tuner 4 will enable a user to select the channel to be recorded and provide an audio and video component corresponding to the selected input signal. In this example, the tuner 4 is analog tuner capable of being used in any broadcast or cable system. However, in other examples, the tuner may be a digital tuner.

Connectors 8 are also included to provide an alternative input signal to the device. Examples of alternative inputs are other video signals from other sources such as a video camera, DVD player, VCR or a set top box device. The connectors 8 also provide outputs from the device. An example of such an output would be a television or a monitor to display the program recorded. Both the tuner 4 and connectors 8 are input to an audio/video 10 matrix switch 6. During operation, the matrix switch 6 selects an input signal from either the tuner 4 or connectors 8 based on user input. The matrix switch 6 then routes the selected signal to the rest of the device. The matrix switch 6 will also route an output signal from the device to the connectors 8.

An analog to digital converter 10 is included to convert the audio component of the input signal to digital. A digital to analog converter 12 is also included to convert the audio component of the output signal to analog. A video input processor 22 is also included to process the video component of the input signal. The video input processor 22 determines the format of the video component. For example, the video component may be a RGB, YUV signal . . . etc. It is necessary to know this in order to later compress the video component. The video input processor 22 also extracts information from the video component such as copy protection status or whether the video component is a PAL or NTSC signal. Further, the video input processor 22 will also convert the video component of the input signal to digital.

In this example, the audio and video components are converted from analog to digital and vice versa. However, in other examples where the input signal is digital this will not be necessary.

As can be seen, the analog to digital converter 10, digital to analog converter 12 and video input processor 22 are connected to an audio/video decoder and encoder 24. The audio/video decoder and encoder 24 is used to compress the audio and video component of the input signal before being recorded on one of the storage devices. The audio/video decoder and encoder 24 is also used to de-compress the audio and video component of the output signal received from one of the storage devices. In one example, the audio/video decoder and encoder 24 will implement the MPEG-2 coding scheme. However, in other examples, other schemes may be used such as MPEG-1, MPEG-4 or other suitable coding scheme. The audio/video decoder and encoder 24 is also used to control the two storage devices 26,28.

It should be noted that the audio/video decoder and encoder 24 and video input processor 22 may be implemented as separate units. Alternatively, the audio/video decoder and encoder 24 and video input processor 22 may be implemented as a single unit such as a Chrysalis hardware platform. A 1394 physical layer (PHY) 20 is also connected to the audio/video decoder and encoder 24. The 1394 PHY will enable the device to be connected to a 1394 network so that digital video (DV) data may also be received and stored in the device.

The device also includes two storage devices including hard disk drive 26 and a DVD recorder 28. In one example, the DVD recorder 28 is a DVD+RW recorder. However, in other examples, the DVD recorder may be embodied by a DVD+R, DVD-R or a DVD-RW recorder.

A portion of the storage space in the hard disk drive 26 is set aside as a buffer that is used to continuously store the input signal selected by the user. This buffer is more particularly described as a time shift buffer since it enables a user to pause, rewind or fast-forward from an earlier portion of the input signal. The amount of the space set aside as the time shift buffer will be a factor in determining the capacity of the buffer. The coding scheme will be another factor that affects the capacity of the time shift buffer. For example, a coding scheme that has a higher level of compression will increase the capacity of the buffer. The size of the time shift buffer can be set based on user input. The size of the time shift buffer may be set to a size of one, two, three, six hours or any other suitable size. The rest of the space in the hard disk drive 26 may be used as additional storage. For example, the contents of the time shift buffer may be transferred to this other space. Further, camera recordings, direct recordings or DVD images from a DVD disc may also be stored on the space not reserved as the time shift buffer on the hard disk drive 26.

The DVD recorder 28 may be used to provide more permanent storage. For example, the contents of the hard disk drive 26 may be recorded on DVD disk by the DVD-recorder 28. Further, the input signal selected by the user may also be recorded on DVD disk by the DVD recorder 28.

Connected between the audio/video decoder and encoder 24 and the IO matrix switch 6 is an electronic program guide (EPG) unit 14. The EPG unit 14 will extract any EPG information included in the input signal and store it in an internal cache. If the input signal is an analog television signal, the EPG information will be included in the vertical blanking interval of the input signal. If the input signal is a digital signal, the EPG information may be included in a separate channel or sideband. For example, in the Digital Video Broadcasting (DVB) format, the EPG information is included in event information tables (EIT).

During operation, the EPG unit 14 will use the extracted information to generate graphics for an EPG display. The EPG graphics will be inserted into the video component of the output signal by the EPG unit 14 so that the EPG may be shown on a display. Further during operation, the EPG unit 14 will route the video component back to the IO matrix switch 6 even when an EPG is not inserted. Further, the EPG unit 14 will also provide information about the program being recorded to the controller. This information may include, but not limited to, program name, genre, start time and duration of the program.

A controller 16 is included that controls various elements within device such as the tuner 4, IO matrix switch 6, EPG unit 14 and the audio/video decoder and encoder 24. A front panel 18 of the device is connected to the controller 16 by a bus 34. The front panel 18 includes a display and keys. The display shows information about the device such as the current channel being recorded. The keys are similar to ones that would be on a remote control such as the channel changer or EPG navigation keys.

During operation, user inputs may be sent to the controller 16 via a remote control or the front panel 18. As can be seen, the controller 16 is connected to the IO matrix switch 6 by another bus 30. During operation, the controller 16 will tell the IO matrix unit 6 which input signal to select based on user input. The controller 16 is also connected to the tuner 4 by another bus 36. The controller 16 will also set the channel of the tuner 4 based on user input.

The controller 16 is also connected to the EPG unit 14 by another bus 32. During operation, the controller 16 will start and stop the EPG unit 14. The controller 16 will also relay navigation commands to the EPG unit 14 that were input by the user via the EPG navigation keys. This will enable a user to scroll up and down the EPG being displayed. The EPG unit 14 will also provide EPG information to the controller 16 such as program name, genre, start time and duration of the program being recorded. This will enable the controller 16 to detect when a program change occurs in the input signal.

The controller 16 is also connected to the audio/video decoder and encoder 24. The controller 16 will tell the audio/video decoder and encoder 24 when to encode the input signal and decode the output signal. The controller 16 will also provide EPG information to the audio/video decoder and encoder 24 so that it may also be stored on the hard disk drive 26. As previously described, this information includes program name, genre, start time and duration of the program being recorded.

The controller 16 will also tell the audio/video decoder and encoder 24 of any changes in the input signal such as a channel change or program change. Thus, during operation, the audio/video decoder and encoder 24 will then insert a program marker in the buffer of the hard disk drive 26 indicating where these changes occur if certain conditions are met. The details of this will be described in detail below.

The controller 16 may be implemented by a programmable microprocessor. Further, the buses 30,32,34,36 may be implemented by a standard bus such as an I²C bus.

During operation, the user will select the input signal to be recorded by the device by way of a remote control or front panel 18. As previously described, a television signal from either the tuner 4 or an alternative signal from the connectors 8 may be selected. If the tuner 4 is selected, the user will select the channel to be recorded by way of a remote control or front panel 18. The controller 16 will then set the channel of the tuner 4 to the one selected by the user. The controller 16 will also tell the IO matrix switch 6 to take the input from the tuner 4. Thus, an audio signal component and video signal component corresponding to the selected channel will be input into the IO matrix switch 6. The IO matrix switch 6 will then route the audio component to the analog to digital converter 10 and the video component to the video input processor 22.

The EPG unit 14 will also begin to extract the EPG information associated with the selected channel and provide this information to the controller 16. As previously described, this information includes program name, genre, start time and duration of the program being recorded. The analog to digital converter 10 will convert the audio component into a digital signal. The video input processor 22 will process the video component including converting it into digital. The digital outputs from the analog to digital converter 10 and the video input processor 22 are then provided to the audio/video decoder and encoder 24. The audio/video decoder and encoder 24 will begin to compress these inputs under the direction of the controller 16.

After being compressed, the audio and video components from the audio/video decoder and encoder 24 will be output to the hard disk drive 26 to be stored in the time shift buffer along with EPG information from the controller 16. The input signal will be continually processed and stored in the time shift buffer as described above until the capacity of the time shift buffer is exceeded. As the capacity of the buffer is exceeded, the oldest portion of the input signal will be discarded and the more recent portion will be stored.

Further, the audio/video decoder and encoder 24 will also insert program markers into the time shift buffer if the controller 16 detects a program change. A program change may include when a user changes the channel of the input signal or if a new program starts on the same channel.

For example, if the user requests a channel change, the controller 16 will change the channel of the tuner 4 to the one requested by the user. The controller 16 will then tell the audio/video decoder and encoder 24 to insert a program marker in the time shift buffer at the point where the change occurred. In one example, a program marker will be inserted no matter how long the tuner 4 stays on the new channel. However, in another example, a program marker will only be inserted if the tuner 4 stays on the new channel for a predetermined period of time and the new program has a duration greater than the predetermined time period. This predetermined period of time may be 20, 30, 60 or 120 seconds.

During operation, if a new program starts in the same channel, the EPG unit 14 will provide information to the controller 16 about the new program. This will enable the controller 16 to detect this program change. The controller 16 will then tell the audio/video decoder and encoder 24 to insert a program marker in the time shift buffer at the point where the program change occurred. In one example, a program marker will be inserted no matter how long the duration of the new program. However, in another example, a program marker will only be inserted if the new program has a duration of a predetermined period of time. This predetermined period of time may be 20, 30, 60 or 120 seconds.

In storing the input signal in the time shift buffer other information may be included. In one example, a characteristic point information (CPI) file may also be stored in the time shift buffer along with the program markers, compressed audio and video components. The CPI file will describe how the audio information, video information and the program markers are organized on the hard disk drive 26. This will enable the information to be randomly accessed and to use the fast forward or reverse modes. The CPI file will also indicate what part of the input signal is copy-protected and what compression mode is used. As described above, the program markers inserted into the time shift buffer will indicate that a program change has occurred in the input signal such as when the user changes the channel or when a new program starts in the same channel. These program markers will enable a user to quickly navigate within the time shift buffer. For example, the user will be able to jump from marker to marker to see the different programs recorded in the time shift buffer. In on example, a single button on a remote control could be used to move from marker to marker instead of using a fast-forward or rewind operation.

FIG. 2 shows one example of programs being stored in a time shift buffer according to the present invention. As can be seen, program A on channel 1 was the first program recorded in the time shift buffer. Thus, the tuner of the device was first set to channel 1. After a period of time, there is a change to channel-2 and program B begins being recorded. Thus, a program marker 25 is inserted in the time shift buffer at the point where the channel changes occur. Further, after a period of time, Program B ends and Program C begins being recorded. Thus, a program marker 25 is inserted in the time shift buffer at the point where the program changes from B to C. After a period of time, there is a change to channel-3 and program E begins being recorded. Thus, a program marker 25 is inserted in the time shift buffer at the point where the channel changes occur.

FIG. 3 shows another example of programs being stored in a time shift buffer according to the present invention. In this example, program markers are inserted into the time shift buffer to indicate a change in channel if the tuner stays on the new channel for a predetermined period of time. As can be seen, program A on channel-1 was the first program recorded in the time shift buffer. Thus, the tuner of the device was first set to channel-1.

After a period of time, there is a change to channel-2 and program B begins being recorded. After a short period of time, there is a change to channel-3 and program C begins being recorded. Thus, a program marker was not inserted into the time shift buffer marking the change from channel-1 to channel-2 since the tuner did not stay on channel-2 for a predetermined period of time. After another short period of time, there is a change again to channel-4 and program D begins being recorded. Thus, a program marker was not inserted into the time shift buffer marking the change from channel-2 to channel-3 since the tuner did not stay on channel-3 for a predetermined period of time. However, a program marker 25 was inserted in the time shift buffer marking the change from channel-3 to channel-4 since the tuner did stay on channel-4 for a predetermined period of time.

FIG. 4 shows another example of programs being stored in a time shift buffer according to the present invention. In this example, program markers are inserted in the time shift buffer for a program change if the new program has a duration of a predetermined time period. Thus, a program marker will not be inserted if the new program has a short duration that is less than the predetermined time period. A new program may have a short duration when a channel change occurs and the program on the new channel is close to the end.

As can be seen, there is a change from channel-3 to channel-4 and program D begins to be recorded. However, after a short period of time, the program changes to E and program E begins to be recorded. In this example, the tuner does stay on channel 4 for the predetermined time period. However, since program D has a short duration, a program marker will not be inserted in the time shift buffer marking the change from channel 3 to channel-4 since program D had a duration less than the predetermined period. However, in this example, a program marker is inserted into the time shift buffer marking the program change from program D to E since program E has a duration greater than the predetermined time period.

FIG. 5 shows another example of programs being stored in a time shift buffer according to the present invention. As can be seen, this example is the same as FIG. 4 except that there was a change from channel-3 to channel-4 farther away from the end of program D. Thus, the duration of program D is longer than the predetermined period. Therefore, a program marker is inserted in the time shift buffer marking the change from channel-3 to channel-4.

In describing FIGS. 3-5, program markers are inserted into the time shift buffer marking program changes if the tuner stays on the new channel for a predetermined period of time and/or if the new program has a duration of a predetermined period of time. According to the present invention, the timing of when the program marker is inserted in the time shift buffer may vary. In one example, at the time of the change in channel or program, the program marker is inserted and after the predetermined period the program marker is removed if the predetermined time period is not met. In another example, the program marker is not inserted at the time of the change in channel or program and if the predetermined period is met, the program marker is then inserted in the time shift buffer at the time it occurred.

While the present invention has been described above in terms of specific examples, it is to be understood that the invention is not intended to be confined or limited to the examples disclosed herein. Therefore, the present invention is intended to cover various structures and modifications thereof included within the spirit and scope of the appended claims.

1. A method of recording an audio and video input signal, comprising the steps of:
receiving the input signal;
storing the input signal in a buffer;
detecting a program change in the input signal; and
inserting a program marker into the buffer corresponding to the program change.

2. The method of claim 1, which further includes compressing the input signal.

3. The method of claim 1, wherein the inserting a program marker is performed if the program change is for a predetermined period of time.

4. The method of claim 1, wherein the program change is a change from a first channel to a second channel.

5. The method of claim 4, wherein the inserting a program marker is performed if the second channel has a duration of more than a predetermined period.

6. The method of claim 4, wherein the inserting a program marker is performed if a program on the second channel has a duration of more than a predetermined time period.

7. The method of claim 1, wherein the program change is a change from a first program to a second program on the same channel.

8. The method of claim 7, wherein the inserting a program marker is performed if a second program has a duration of more than a predetermined time period.

9. A device for recording an audio and video input signal, comprising:
a switch (6) for receiving the input signal;
an audio and video coding unit (24) for encoding the input signal;
a buffer for storing the encoded input signal; and
a controller (16) for detecting a program change in the input signal and inserting a program marker into the buffer corresponding to the program change.

10. The device of claim 9, wherein the (16) controller inserts the program marker if the program change is for a predetermined period of time.

11. The device of claim 9, wherein the program change is a change from a first channel to a second channel.

12. The device of claim 11, wherein the controller (16) inserts the program marker if the second channel has a duration of more than a predetermined period.

13. The device of claim 11, wherein the controller (16) inserts a program marker if a program on the second channel has a duration of more than a predetermined time period.

14. The device of claim 9, wherein the program change is a change from a first program to a second program on the same channel.

15. The device of claim 14, wherein the controller (16) inserts the program marker if the second program has a duration of more than a predetermined time period.

16. The device of claim 9, which further includes a tuner (4) coupled to the switch (6) for providing the input signal.

17. The device of claim 9, which further includes a connector (8) coupled to the switch (6) for providing the input signal.

18. The device of claim 9, wherein the buffer is a predetermined amount of space in a hard disk drive 26.

19. The device of claim 9, which further includes a DVD recorder (28) coupled to the audio and video coding unit.

20. The device of claim 14, which further includes an electronic program unit (14) for notifying the controller of the change from the first program to the second program.
